(19) United States
(12) Patent Application Publication
(10) Pub. No.: US 2025/0223932 A1
(43) Pub. Date: Jul. 10, 2025

(54) ENGINE SIGNAL GENERATOR

(71) Applicant: MAHLE International GmbH, Stuttgart (DE)

(72) Inventors: Reiji Sato, Shizuoka (JP); Tomoaki Sekita, Shizuoka (JP); Koyo Mishuku, Shizuoka (JP)

(21) Appl. No.: 19/014,166

(22) Filed: Jan. 8, 2025

(30) Foreign Application Priority Data
Jan. 9, 2024 (JP) 2024-001383

(51) Int. Cl. F02D 41/00; F02D 41/06; F02D 41/20; F02P 7/067

(52) U.S. Cl. CPC F02D 41/009; F02D 41/062; F02D 41/20; F02P 7/0677; F02D 2041/2048

(57) ABSTRACT

A signal generating device for an engine may include a rotor and a stator. The rotor may include a reluctor including a first step reluctor and a second step reluctor. The stator may include a stator iron core, a signal coil, and a permanent magnet. The stator may be configured to induce a first signal and a second signal having the same polarity in the signal coil as a result of changes that occur in the magnetic flux when the tip of each of the step reluctors starts to face the magnetic pole of the stator iron core. A deformed part of the first step reluctor and/or the stator iron core may be configured to control the changes in the magnetic flux such that a crest value of the first signal is limitable to a value that is equal to or less than a crest value of the second signal.

### CROSS REFERENCE TO RELATED APPLICATIONS

This application claims priority to JP2024-001383, filed Jan. 9, 2024, the content of which is hereby incorporated by reference in its entirety.

### TECHNICAL FIELD

The present invention relates to a signal generating device for an engine to generate a signal that includes crank angle information for the engine (internal combustion engine).

### BACKGROUND

In order for an engine to operate, it is necessary to control the ignition timing and fuel injection timing for each cylinder of the engine. In engine control, the timing to force the execution of a specified operation, such as ignition operation or fuel injection operation, is determined using the crank angle when causing each operation to be executed. The crank angle is the angle of rotation of the crank shaft that may be measured when treating the origin (0 degrees) as a specific position, such as the position of the crank shaft when the engine piston reaches the top dead center (top dead point position).

The engine crank angle information is required when controlling engine ignition and fuel injection timing. The crank angle information required to control the ignition timing and fuel injection timing of the engine may be, for example, crank angle information indicating the origin position (usually zero degrees) set near the top dead center (TDC) or the top dead point of the piston of the engine, or reference crank angle information that is the crank angle that represents the measurement start timing, which is the timing to start the measurement of the ignition timing and fuel injection timing.

The engine signal generating device outputs various signals required for engine control as the crank shaft of the engine rotates, such as signals with crank angle information indicating the crank shaft origin position and signals with reference crank angle information that gives the timing of ignition and the timing of starting the fuel injection timing measurements. The engine control unit obtains the engine crank angle information from the signal generated by the engine signal generating device and controls the timing of engine ignition and fuel injection.

For example, when the engine control unit controls the ignition operation of each cylinder of the engine, the signal generating device detects the engine rotation speed based on the interval at which a predetermined signal is generated, and calculates this ignition angle for various control conditions with the crank angle at the origin position when the piston of each cylinder reaches the position set at the top dead center, etc., and the angle from the origin position to the crank angle at which the ignition timing is given as the ignition angle. When treating the crank angle that is more advanced than the most advanced ignition angle as the reference crank angle, the control unit calculates the time required for the crank shaft to rotate from the reference crank angle to the calculated ignition angle at the rotation speed when the engine signal generating device recognizes that a signal indicating the reference crank angle has been generated, and sets the calculated time in the timer. The engine control unit provides an ignition command to the ignition device to perform the ignition operation when the timer completes the time measurement that had been set.

If the engine has multiple cylinders, the signal generated by the engine signal generating device includes a signal corresponding to each of the multiple cylinders because the engine must control the ignition and fuel injection operation of each cylinder. Therefore, when controlling the ignition and fuel injection operation of each cylinder of the engine, it is necessary to determine for which cylinder of the engine the signal generating device has generated each signal. This type of assessment that may be made for the signals generated by the signal generating device is called cylinder discrimination.

As a signal generating device for a multi-cylinder engine, as shown in Patent Literature 1, it is common to use an inductor-type signal generating device that consists of a rotor yoke made of ferromagnetic material that may be rotated with the crank shaft of the engine, a rotor provided with a plurality of reluctors (inductors) provided in correspondence with the multiple cylinders of the engine around the perimeter of the rotor yoke, and a stator to generate a pulse waveform signal when each reluctor provided in the rotor is detected.

The stator has a stator iron core having a magnetic pole opposite the surface on which the rotor reluctor is provided at the tip, a signal coil wound about the stator iron core, and a permanent magnet that is magnetically coupled to the stator iron core. The stator causes the signal coil to induce a pulse waveform signal by causing a change in the amount of magnetic flux flowing through the stator iron core as the rotor reluctor passes through the position of the magnetic pole at the tip of the stator iron core.

The engine signal generating device shown in Patent Literature 1 is configured to continuously generate two cylinder discrimination pulses of the same polarity from the signal coil at a crank angle having a predetermined phase relationship in relation to a reference crank angle that has been set to a position that is further advanced from the origin position of the crank shaft when using one of the plurality of reluctors provided in the rotor as a stepped reluctor having a stepped shape in order to enable cylinder discrimination of the signals.

With the signal generating device configured as described above, it will be possible to detect that a pulse signal for cylinder discrimination has been generated because two pulse signals of the same polarity have occurred consecutively, and it will be possible to determine that a pulse signal having a predetermined phase relationship for either cylinder discrimination pulse is the signal generated at a reference crank angle set for a particular cylinder.

(PATENT LITERATURE 1) Japanese Unexamined Patent Application Publication H10-084662

### SUMMARY

By using the signal generating device shown in Patent Literature 1, it will be possible to force the execution of the cylinder discrimination of signals including the crank shaft rotation information without separately installing a cylinder discrimination means such as a cam axis sensor. When the pulse signal obtained from this type of signal generating device is provided to the engine control unit in order to control the engine, the pulse signal generated by the signal generating device will be input into the engine control unit through a signal input circuit that has the function of removing noise to prevent the noise signal from causing the engine control unit to malfunction.

The signal input circuit is equipped with a capacitor at the input part that is charged by the input signal and generates a bias voltage at both ends, and only the portion of the input signal that exceeds said bias voltage will be input into the engine control unit as a signal containing the engine rotation information. The capacitor generating the bias voltage is charged by the pulse signal until the voltage value of the input pulse signal reaches a peak, and may be discharged through the discharge circuit at a certain time constant after the pulse signal reaches the peak.

Referring to FIG. 10A, this diagram shows a schematic of an example of the shape of stepped reluctor R′ that may be provided on the periphery of the rotor of the signal generating device for an engine. FIG. 10B shows an example of the waveform of pulse signals P1′ and P2′ induced by a signal coil wound about the stator core as said reluctor passes through the position of the magnetic pole (not shown in the figure) at the tip of the stator iron core. Also, FIG. 10C schematically shows an example of the waveform of a signal that may be provided from the signal input circuit to the engine control unit.

Retractor R′ shown in FIG. 10A is provided with arc-shaped first step reluctor Ra′ that is provided such that it extends in an arc shape along the peripheral direction of the rotor with width dimension w1′ and of which tip Ra1′ faces the forward side of the crank shaft rotational direction RD, and second step reluctor Rb′ that is provided such that it extends along with rotational direction of the crank shaft with width dimension w2′ that is larger than width dimension w1′ of first step reluctor Ra′ and of which tip Rb1′ continues from back end Ra2′ of first step reluctor Ra′ and back end Rb2′ faces the backward side of the rotational direction of the crank shaft.

In this signal generating device, as the amount of magnetic flux flowing through the stator iron core changes to the same direction as tip Ra1′ of first step reluctor Ra′ passes through the position of the magnetic pole of the stator iron core and tip Rb1′ of second step reluctor Rb′ passes through the position of the magnetic pole of the stator iron core, as shown in FIG. 10B, pulse signals P1′ and P2′ of the same polarity are induced in the signal coil as the tip of the first step reluctor passes through the position of the magnetic pole of the stator iron core and the tip of the second step reluctor passes through the position of the magnetic pole of the stator core, respectively. The crest values of pulse signal P1′ and P2′ will vary depending on the relationship between the width dimension of first step reluctor Ra′ and the width dimension of second step reluctor Rb′, and on the relationship between the width dimension of the magnetic pole of the tip of the stator iron core and the width dimension of the reluctors, etc.

In the example shown in FIG. 10B, the crest value of pulse signal P1′ that is induced in the stator signal coil when tip Ra1′ of first step reluctor Ra′ of the rotor passes the position of the magnetic pole at the tip of the stator iron core will be larger than the crest value of pulse signal P2′ that is induced in the stator signal coil when the tip of second step reluctor Rb′ of the rotor passes the position of the magnetic pole at the tip of the stator iron core. In FIG. 10B, θ of the horizontal axis shows the crank angle.

In order to prevent the engine control unit from malfunctioning due to noise, the signal shown in FIG. 10B is input into the engine control unit through the signal input circuit provided at the input part of the capacitor that will be charged by the input signal to generate a bias voltage. The capacitor that generates the bias voltage is charged by the input signal until the input signal reaches the peak, and is discharged at a certain time constant starting from when the input signal passes the peak. Therefore, the waveform of the bias voltage Vb that occurs at both ends of the capacitor provided at the input part of the signal input circuit increases linearly until the input signal reaches a peak, and falls at a constant slope from the time point at which the input signal passes the peak, as shown in FIG. 10B.

In the example shown in FIG. 10B, during the period in which pulse signal P1′ that is induced in the signal coil of the stator as the tip of first step reluctor Ra′ of the rotor passes through the position of the magnetic pole of the tip of the stator iron core exceeds the bias voltage Vb, signal Q1′ is provided to the engine control unit and the engine rotation information provided by signal P1′ is provided to the engine control unit, as shown in FIG. 10C.

On the other hand, pulse signal P2′ that is induced in the signal coil when tip Rb1′ of second step reluctor Rb′ of the rotor passes through the position of the magnetic pole of the stator iron core cannot exceed the bias voltage Vb, so it is recognized to be noise, and the rotation information of the engine having pulse signal P2′ is not provided to the engine control unit.

As described above, if the crest value of pulse signal P1′ that may be generated when the stator detects the first step reluctor is higher than the crest value of pulse signal P2′ that may be generated when the stator detects the second step reluctor, it may not be possible to provide the control unit with the engine rotation information having pulse signal P2′ that was generated when the second step reluctor was detected, so it will not be possible to properly control the engine.

Patent Literature 1 states that, by setting width dimension W1′ of first step reluctor Ra′ to be smaller than the width dimension of the magnetic pole of the stator iron core, and by setting width dimension W2′ of second step reluctor Rb′ to be larger than the width dimension of the magnetic pole of the stator iron core, the crest value of pulse signal P1′ that may be induced in the signal coil of the stator as the tip of first step reluctor Ra′ of the rotor passes through the position of the magnetic pole of the tip of the stator iron core will be the same as the crest value of pulse signal P2′ that may be induced in the stator signal coil as the tip of second step reluctor Rb′ of the rotor passes through the position of the magnetic pole of the tip of the stator iron core.

However, when set as described above, width dimension W2′ of second step reactor Rb′ increases and the reluctor grows larger in size, making it difficult to balance the rotor, so this is not desirable. In order to prevent the reluctor from becoming larger in size, it is possible to set the width dimension of the magnetic pole of the stator iron core to a smaller size, but if the width dimension of the magnetic pole of the stator iron core is set to a smaller size, the width dimension of the first step reluctor will become too small, and the strength of the first step reluctor will decrease, so first step reluctor Ra′ may be damaged when the rotor is attached to the engine, etc., which is undesirable.

The objective of the present invention is to provide an engine signal generating device in which the crest value of the pulse signal that may be generated when the stator detects the first step reluctor will be equal to or less than the crest value of the pulse signal that may be generated when the stator detects the second step reluctor, without causing the stepped reluctor to become larger or causing the width dimension of the first step reluctor to become too small, leading to a decrease in the strength of the reluctor, ensuring that the signals generated later will not be recognized by the engine control unit.

The present invention may be applied to a signal generating device for an engine that is provided with a rotor that can be rotated along with the engine crank shaft and that is equipped in the outer periphery of the rotor yoke with a reluctor having a first step reluctor with a first width dimension that is provided such that it extends in the rotational direction of the engine crank shaft and of which the tip faces the forward direction of the rotational direction of said crank shaft and a second step reluctor with a second width dimension that is larger than said first width dimension that is provided such that it extends in the rotational direction of said crank shaft and of which the tip is integrated with the rear end of said first step reluctor, and a stator that has a stator iron core having a magnetic pole at its tip that will be sequentially faced by the first step reluctor and the second step reluctor of said rotor during the process in which the engine crank shaft rotates, a signal coil that is wound about said stator iron core, and a permanent magnet that is magnetically coupled with said stator iron core and that will flow magnetic flux into the magnetic path that includes said stator iron core and said rotor reluctors, wherein said stator will induce the first signal and the second signal having the same polarity in said signal coil as a result of the changes that will occur in said magnetic flux when the tip of said first step reluctor starts to face the magnetic pole of said stator iron core and when the tip of said second step reluctor starts to face the magnetic pole of said stator iron core.

In the present invention, the crest value of said first signal is restricted to a value that is equal to or less than the crest value of said second signal by providing a part that is deformed in the tip of said first step reluctor and (or) the magnetic pole of said stator iron core such that it will be possible to control the changes that may occur in the magnetic flux that will flow through the stator iron core when the tip of said rotor first step reluctor starts to face the magnetic pole of the stator iron core.

In one aspect of the invention, a part having a roundness is formed at the tip of the first step reluctor of said rotor, and the portion having this roundness constitutes said deformed part.

The rotor of the signal generating device to which the present invention may be applied may be manufactured by means of a method of forming a reluctor by pressing a plate of ferromagnetic material such as iron to form a cup-shaped rotor yoke, and then stamping a portion of the periphery wall of said rotor yoke radially towards the outside, or it may be manufactured through casting.

If the rotor is manufactured by means of a method of forming a rotor yoke by pressing and then stamping a portion of the rotor yoke peripheral wall radially towards the outside to form the reluctor, said part having roundness as described above can be formed by performing R-chamfering of the tip of the first step reluctor.

In addition, when a rotor equipped with a reluctor is manufactured by casting, a part having a roundness is necessarily formed at the tip of the first step reluctor, so it will be possible to provide a part having a roundness at the tip of the first step reluctor without performing R-chamfering of the tip of the first step reluctor.

In another aspect of the invention, of each part of the corners of the magnetic pole at the tip of the stator iron core, a part having roundness may be formed in the part that will be first to face the tip of said first step reluctor during the process of the rotation of said rotor, and said part having roundness constitutes said deformed part.

Also, of each part of the corners of the magnetic pole at the tip of the stator iron core, when forming a part having roundness in the part that will be first to face the tip of said first step reluctor during the process of the rotation of said rotor, as necessary, it is also possible to provide a deformed part such that there will be roundness at the tip of the first step reluctor of the rotor as well.

Said rotor yoke may be provided solely for configuring the rotor of the signal generating device, or it may be provided for configuring a rotor, etc., of a generator attached to the engine.

In the present invention, because a deformed part is provided at the tip of the first step reluctor of the rotor and (or) in the magnetic pole of the stator iron core such that it can act to control the changes that may occur in the magnetic flux flowing through the stator iron core when the tip of the first step reluctor of the rotor starts to face the magnetic pole of the stator iron core, ensuring that the crest value of the first signal that may be induced in the signal coil when the first step reluctor starts to face the magnetic pole of the stator iron core will be equal to or less than the crest value of the second signal that may be induced in the signal coil when the second step reluctor starts to face the magnetic pole of the stator iron core, it will be possible to ensure that the crest value of the pulse signal that may be generated when the stator detects the first step reluctor is a size that is equal to or less than the crest value of the pulse signal that may be generated when the stator has detected the second step reluctor, preventing the occurrence of an event in which the engine control unit fails to recognize the signals generated after that, without causing any increase in the size of the reluctor due to an increase in the width dimension of the second step reluctor of the stepped reluctor and without causing any decrease in the strength of the first step reluctor because the width dimension of the first step reluctor has been excessively reduced.

### BRIEF DESCRIPTION OF THE DRAWINGS

FIG. 1 is a front view diagram that schematically illustrates the configuration of an example of embodiment of the signal generating device according to the present invention.

FIG. 2 is an expanded view showing an example of the shape of the stepped reluctor of the rotor (cylindrical surface of the circumference of the rotor) used in one example of embodiment of the present invention as viewed from the outside of the rotor along the radial direction of said rotor, with the cylindrical surface of the rotor extended in a planar fashion.

FIG. 3A shows an example of the shape when the stepped reluctor provided on the circumference of the rotor used in an example of embodiment of the present invention is viewed along the radial direction from the outside of the rotor.

FIG. 3B shows an example of the shape when the reluctor of FIG. 3A is viewed along the axial direction of the rotor such that its thickness is visible.

FIG. 4A is an expanded view showing an example of the shape of the stepped reluctor used in another example of embodiment of the present invention as viewed from outside of the rotor along the radial direction of the rotor.

FIG. 4B is an expanded view showing an example of the shape of the stepped reluctor as viewed along the axial direction of the rotor.

FIG. 5A is a side view diagram that schematically illustrates the configuration of the stator that may be used in one example of embodiment of the present invention.

FIG. 5B is a cross-sectional view of the stator shown along the VB-VB line in FIG. 5A.

FIG. 6 is a waveform diagram that schematically shows an example of the waveform of the pulse signal that the signal generating device according to the present invention may generate during one revolution of the crank shaft of the engine relative to the angle of rotation θ of the crank shaft.

FIG. 7 is a circuit diagram showing the state of the connection of the signal coil of the signal generating device according to the present invention to the microprocessor of the engine control unit via the signal input circuit.

FIG. 8A is an unfolded diagram that schematically illustrates the shape of the stepped reluctor provided in the signal generating device to which the present invention may be applied.

FIG. 8B is a waveform diagram showing an example of the signal that may be generated from the signal coil of the stator when the reluctor shown in FIG. 8A passes the position of the magnetic pole of the tip of the stator iron core.

FIG. 8C is a waveform diagram that schematically illustrates the waveform of the signal that may be inputted into the microprocessor of the control unit when the signal shown in FIG. 8B is provided to the control unit for the engine via the signal input circuit.

FIG. 9A is a cross-sectional view illustrating a key part of another example of embodiment of the present invention.

FIG. 9B is a cross-sectional view of the portion of the stator core shown in FIG. 9A along the IXB-IXB line.

FIG. 10A is an unfolded diagram that schematically shows the shape of the stepped reluctor provided in a conventional signal generating device.

FIG. 10B is a waveform diagram illustrating an example of the signal that may be generated as the reluctor shown in FIG. 10A passes through the position of the magnetic pole of the tip of the stator core.

FIG. 10C is a waveform diagram that schematically illustrates the waveform of the signal that may be inputted into the microprocessor when the signal shown in FIG. 10B is provided to the engine control unit via the signal input circuit.

### DETAILED DESCRIPTION

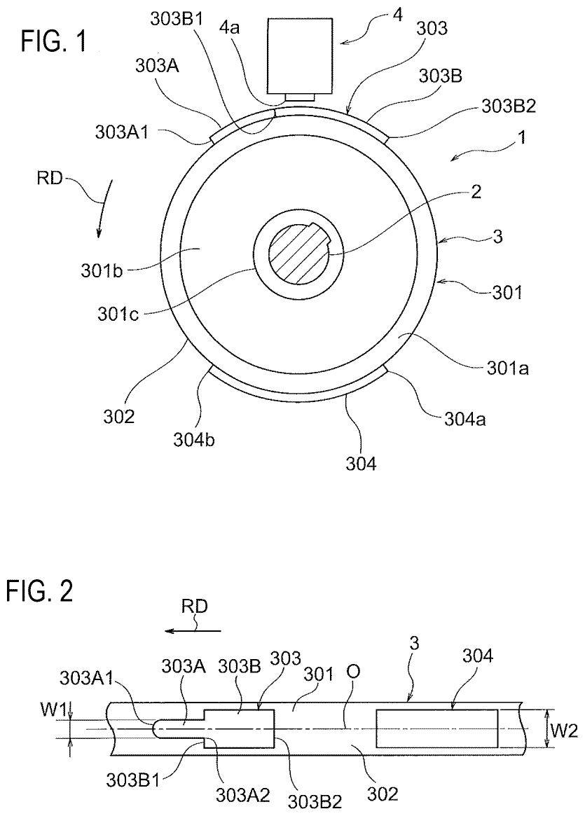

FIG. 1 schematically shows the configuration of one example of embodiment of engine signal generating device 1 according to the present invention. Signal generating device 1 shown in the figure is constructed of rotor 3 that is mounted on crank shaft 2 of the engine and that may be rotated with the engine, and stator 4. Stator 4 is attached to a stator mounting section (not shown in the figure) that may be provided in an engine case or in the frame, etc., to which the engine is fixed, and it may be arranged in a state in which it is anchored in relation to the engine case.

Rotor 3 is provided with cup-shaped rotor yoke 301 that is attached to crank shaft 2 of the engine. Rotor yoke 301 may be provided exclusively for configuring the rotor of the signal generating device or it may be an accessory to the engine that is rotated with crank shaft 2, such as a flywheel attached to the crank shaft of the engine, or a pulley attached to the crank shaft of the engine and coupled via a belt to the fan for engine cooling.

In this example of embodiment, a flywheel mounted to the crank shaft of the engine is used as rotor yoke 301. Rotor yoke 301 may also be a rotor yoke of a magnet generator that may be driven by the engine.

Rotor yoke 301 shown in this figure has a cup shape that includes cylindrical peripheral wall 301a and bottom wall 301b that closes one end of the axial direction of peripheral wall 301a. Boss 301c is formed in the center of bottom wall 301b, and rotor yoke 301 is attached to crank shaft 2 by fitting boss 301c to crank shaft 2 of the engine and keying it to the crank shaft. The outer circumferential surface of rotor yoke 301a forms cylindrical surface 302 that shares a central axis with crank shaft 2.

The circumferential portion formed of at least cylindrical surface 302 of the rotor 3 is formed by a ferromagnetic material such as iron, and the portion formed by this ferromagnetic material may be formed with first reluctor 303 and second reluctor 304 that face the magnetic pole of the stator, which will be described later.

In the present example of embodiment, the engine has two cylinders, and first reluctor 303 and second reluctor 304 may be provided corresponding to the first and second cylinders of the engine, respectively. First reluctor 303 and second reluctor 304 may be arranged at symmetric locations 180 degrees apart from each other.

Each reluctor consists of an arc-shaped protrusion extending in the circumferential direction of the rotor, and together with the stator iron core, which will be described later, constitutes a closed magnetic path during the process of the rotation of the rotor. By causing a change in the magnetic resistance of said closed magnetic path when the rotation angle (crank angle) of rotor 3 matches a set angle, there will be a change in the magnetic flux that is interlinked with the signal coil wound about the stator iron core, causing the signal coil to output a signal containing information about the crank angle. The structure of the stator will be described below.

In the example shown in FIG. 1, the entirety of rotor yoke 301 is formed of a ferromagnetic material such as iron, and first reluctor 303 and second reluctor 304 are formed on cylindrical surface 302 of rotor yoke 301, as shown in FIG. 2. In the example shown in this figure, reluctor 303 and reluctor 304 are formed approximately in the middle in the width direction of cylindrical surface 302 of the rotor yoke (the direction along the center axis of the rotor). It should be noted that reluctor 303 and reluctor 304 need not necessarily be arranged in the middle in the width direction of cylindrical surface 302 of the rotor 3, but may be arranged in one side in the width direction of the cylindrical surface of rotor 3.

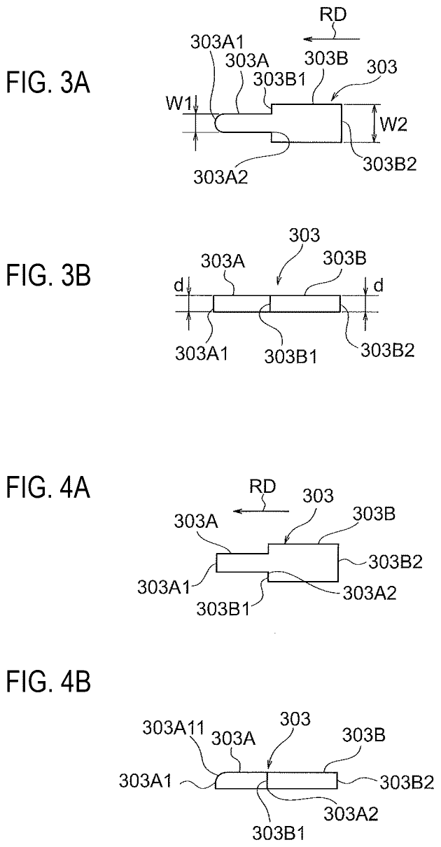

First reluctor 303 is constructed of a so-called stepped reluctor. As shown in FIGS. 3A and 3B, first reluctor 303 consists of first step reluctor 303A that extends in an arc shape in the circumferential direction of the rotor with a constant width dimension w1, and second step reluctor 303B that extends in an arc shape in the circumferential direction of the rotor with width dimension w2 that is greater than that of first step reluctor 303A. First step reluctor 303A and second step reluctor 303B are provided in a state in which the position of the center portion in the respective width direction is aligned, and tip 303A1 of first step reluctor 303A is provided in a state in which the front side of rotational direction RD of the rotor is facing forward, while tip 303B1 of second step reluctor 303B is provided in a state in which rear end 303A2 of first step reluctor 303A is facing the rear side of rotational direction RD of the rotor.

As shown in FIG. 2, first step reluctor 303A and second step reluctor 303B are provided such that the center portions of each reluctor in the width directions are located on a circumferentially extending centerline O of the rotor yoke and aligned to match the circumferential direction of rotor 3. In addition, by having the same thickness dimension d in first step reluctor 303A and second step reluctor 303B, a step in the width direction (rotor axial direction) will occur at the boundary of first step reluctor 303A and second step reluctor 303B, but consideration will be given to avoid a step in the thickness direction (rotor diameter direction). As in the case in which a rotor yoke is manufactured by casting, if it is difficult to have uniform thickness dimension d in the parts that make up first step reluctor 303A and the parts that make up second step reluctor 303B of the manufactured rotor yoke, cutting or polishing, etc., may be performed to the parts that make up first step reluctor 303A and second step reluctor 303B, ensuring that the same thickness dimensions d are applied to both to prevent any difference in the thickness direction (rotor diameter direction) between first step reluctor 303A and second step reluctor 303B.

Second reluctor 304 consists of a protrusion that extends in an arc shape in the circumferential direction of the rotor with width dimension W2 that is equal to the width dimension of second step reluctor 303B of first reluctor 304 and a thickness dimension that is equal to the thickness dimension d of first reluctor 304.

First reluctor 303 and second reluctor 304 are arranged in symmetrical positions with an angular spacing of 180 degrees between each other, arranged in a state in which the center positions in each width direction are positioned on a single circular centerline O extending circumferentially around the circumference of the rotor (aligned to match the circumferential direction of the rotor).

In the present example of embodiment, the direction of rotation of crank shaft 2 during constant operation of the engine is the direction of the forward rotation of crank shaft 2. In FIG. 1, the forward direction of crank shaft rotation is indicated by arrow RD. The direction along the center axis of cylindrical surface 302 of rotor 3 (the direction that is perpendicular to the paper surface of FIG. 1) is the width direction of cylindrical surface 302 and each reluctor.

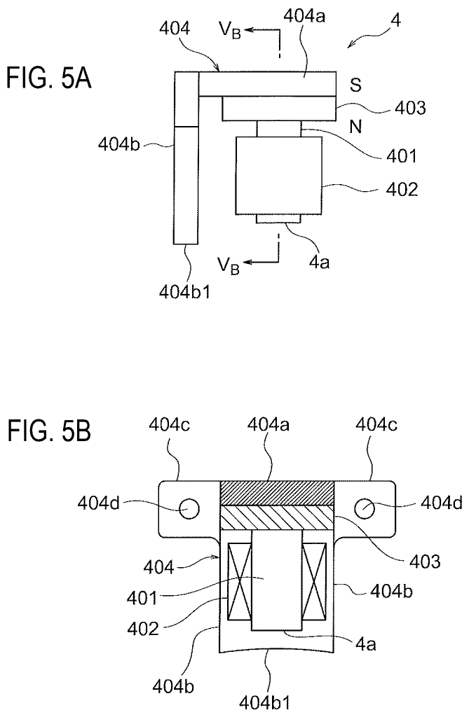

FIGS. 5A and 5B show an example of the configuration of stator 4 that, together with the rotor, constitutes engine signal generating device 1. Stator 4 is provided with stator iron core 401 that may be constructed by laminating a steel plate having a predetermined shape, signal coil 402 that is wound about stator iron core 401, permanent magnet 403 that flows magnetic flux into stator iron core 401, and magnetic path constructional element 404 that is made of a ferromagnetic material such as iron. In stator 4 shown in this figure, the tip of stator iron core 401 forms magnetic pole 4a, and this magnetic pole 4a faces the outer circumferential surface of first reluctor 303 and second reluctor 304 of the rotor via a gap.

Magnetic path constructional element 404 shown in this figure is provided with substrate part 404a that is arranged in a state that is orthogonal to the radial direction of rotor 3, and side plate part 404b that extends from one end of substrate part 404a to the side of rotor 3. At the end of side plate part 404b protruding toward substrate portion 404a, ear parts 404c and 404c are formed in opposite directions to each other, while mounting holes 404d and 404d are formed in ear parts 404c and 404c, respectively.

One magnetic pole of permanent magnet 403 (the S-pole in the illustrated example) is coupled to substrate part 404a of magnetic path constructional element 404, and the rear end of stator iron core 401 is coupled to the other magnetic pole of permanent magnet 403 (the N-pole in the illustrated example).

The members that make up stator 4 are arranged in a predetermined positional relationship either by being coated by a molded portion consisting of insulating resin or being stored in a suitable case with magnetic pole 4a exposed externally and at least ears 404c and 404c and the tip-end part of side plate part 404b of magnetic path constructional element 404b exposed externally.

Stator 4 is attached to the engine such that magnetic pole 4a of the tip of stator iron core 401 will face the area in which the reluctor of rotor 3 has been formed via a gap and side plate part 404b of magnetic path constructional element 404 will face the portion in which the reluctor of rotor 3 is not provided via a gap, using bolts to anchor ears 404c and 404c to the stator mount part (not shown in the figure) that has been anchored onto the case of the engine.

In the present example of embodiment, tip surface 404b1 of side plate part 404b of magnetic path constructional element 404 faces the area lacking the formation of reluctors 303 and 304 near one end in the width direction of cylindrical surface 302 of rotor 3, thereby magnetically coupling magnetic path constructional element 404 to rotor yoke 301.

Magnetic path constructional element 404 may be magnetically coupled to rotor 3 by causing the tip of side plate part 404b to face the part near the periphery of bottom wall 301b of rotor 3, or it may be magnetically coupled to rotor 3 by anchoring it to other suitable members that are magnetically coupled to rotor 3 via a gap.

In engine signal generating device 1 shown in the figure, a magnetic path comprising a stator iron core and a rotor reluctor is constructed between rotor 3 and stator 4, or in other words, a magnetic path is constructed consisting of a loop of permanent magnet 403—stator iron core 401—air gap—rotor 3—air gap—magnetic path constructional element 404—permanent magnet 403, wherein the reluctor changes the magnetic resistance of this magnetic path as rotor 3 rotates, causing a change in the amount of magnetic flux that flows through the iron core and that is interlinked with signal coil 402 to induce a pulse signal in signal coil 402.

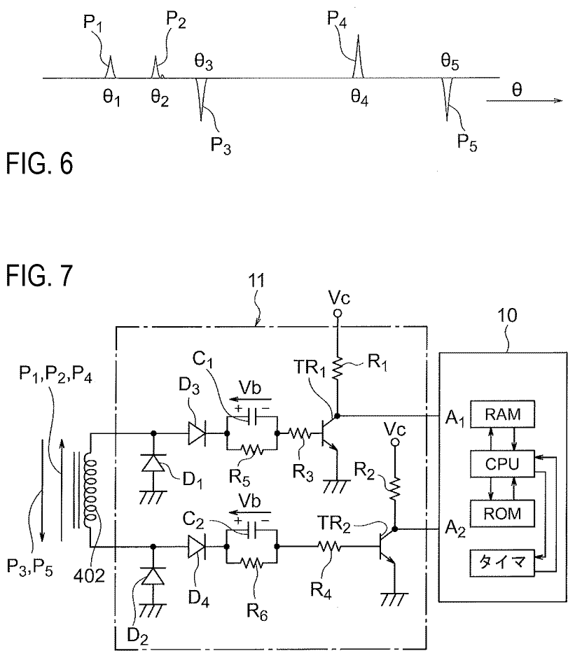

Here, if the polarity of the pulse signal induced in signal coil 402 is set to have positive polarity when the magnetic flux interlinked with signal coil 402 changes in the direction of increasing the magnetic flux interlinked with signal coil 402, and the polarity of the pulse signal induced in signal coil 402 is set to have negative polarity when the magnetic flux interlinked with signal coil 402 changes in the direction to decrease, signal generating device 1 shown in FIG. 1 outputs a series of pulse signals as shown in FIG. 6, for example, accompanying the change in crank angle θ.

In FIG. 6, θ1 is the crank angle when tip 303A1 of first step reluctor 303A of first reluctor (stepped reluctor) 303 starts to face magnetic pole 4a of the tip of stator iron core 401, θ2 is the crank angle when tip 303B1 of second step reluctor 303B of first reluctor 303 starts to face magnetic pole 4a of the tip of stator iron core 401, and θ3 is the crank angle when rear end 303B2 of second step reluctor 303B stops facing magnetic pole 4a of the tip of the stator iron core. In addition, θ4 is the crank angle when tip 304a of second reluctor 304 starts to face magnetic pole 4a of the tip of stator iron core, and θ5 is the crank angle when rear end 304b of second reluctor 304 stops facing magnetic pole 4a of the tip of the stator iron core.

When the tip of first step reluctor 303A of first reluctor 303 at crank angle θ1 starts to face magnetic pole 4a of the stator iron core, a positive polarity pulse signal P1 (first signal) will be induced in signal coil 402 because the amount of magnetic flux flowing through the magnetic path increases and the magnetic flux interlinked with signal coil 402 increases, while when tip 303B1 of second step reluctor 303B of first reluctor 303 starts to face magnetic pole 4a of stator iron core 401 at crank angle θ2, a positive polarity pulse signal P2 (second signal P2) will be induced in signal coil 402 because there will once again be an increase the amount of magnetic flux flowing through said magnetic path, increasing the amount of magnetic flux that is interlinked with the signal coil. In addition, when rear end 303B2 of second step reluctor 303B stops facing magnetic pole 4a of the stator iron core at crank angle θ3, the magnetic flux flowing through the aforementioned magnetic path will be reduced, and the amount of magnetic flux that is interlinked with signal coil 402 is reduced, so a negatively polar pulse signal P3 (third signal) will be induced in the signal coil.

As rotor 1 rotates further, when crank angle θ reaches crank angle θ4 and tip 304a of second reluctor 304 begins to face magnetic pole 4a of stator iron core 401, the amount of magnetic flux flowing through stator iron core 401 increases, and the amount of magnetic flux interlinked with signal coil 402 increases, inducing a positive polarity pulse signal P4 (fourth signal) in signal coil 402. When crank angle θ reaches crank angle θ5, rear end 304b of reluctor 304 stops facing the magnetic pole of the stator iron core, thereby reducing the amount of magnetic flux flowing through the stator iron core and reducing the magnetic flux interlinked with signal coil 402, inducing a negatively polarity pulse signal P5 (fifth signal) in signal coil 402.

In the control unit that may use a signal generating device as described above, the signal output by the signal generating device will be inputted into the microprocessor of the control unit through a signal input circuit having a noise removal function in order to prevent any malfunction due to noise. The signal input circuit is provided with a capacitor that may be charged by the signal input from the signal generating device and a resistor that may discharge the charge of the capacitor at a certain time constant, and it is configured to input into the control unit only the pulse signals having a size that is greater than the bias voltage that may be obtained in both ends of said capacitor.

FIG. 7 shows an example of the configuration of an apparatus for inputting the pulse signals that may be outputted by signal coil 402 of the stator into an engine control unit through a signal input circuit with a bias circuit. In FIG. 7, 10 is a microprocessor provided in the engine control unit and 11 is a signal input circuit that inputs the pulse signals that were outputted by signal coil 402 to ports A1 and A2 of microprocessor 10.

Microprocessor 10 is provided with a CPU, random access memory RAM, read-only memory ROM, and timer, etc., and performs various operations necessary for engine control using information obtained from the pulse signals that may be outputted by signal coil 402.

Signal input circuit 11 consists of NPN transistors TR1 and TR2 in which the emitter is grounded and the collector is connected to ports A1 and A2 of the microprocessor, respectively, resistance R1 that is connected between the collector of transistor TR1 and the output end of the power supply circuit (not shown in the figure) to output power supply voltage Vc, resistance R2 that is connected between the collector of transistor TR2 and the output end of the power supply circuit (not shown in the figure), and a bias circuit that is provided between signal coil 402 and the base of transistors TR1 and TR2.

The bias circuit consists of diode D1 that is connected between one end of signal coil 402 and the earth potential part with the cathode facing one end side of signal coil 402, diode D2 that is connected between the other end of signal coil 402 and the earth potential part with the cathode facing the other end side of signal coil 402, diodes D3 and D4 of which the cathodes are connected to one end and the other end of signal coil 402, capacitor C1 of which one end is connected to the cathode of diode D3 and of which the other end is connected to the base of transistor TR1 via resistance R3, capacitor C2 of which one end is connected to the cathode of diode D4 and of which the other end is connected to the base of transistor TR2 via resistance R4, and resistance R5 and R6 that are each connected in parallel to capacitors C1 and C2.

In FIG. 7, when signal coil 402 generates the positive polarity pulse signals P1, P2, and P4, the current flows through the path consisting of signal coil 402—diode D3—capacitor C1—resistance R3—base emitter circuit of transistor TR1—diode D2—signal coil 402. As a result, transistor TR1 will conduct, reducing the potential of its collector and reducing the potential of port A1 of microprocessor 10. When the potential of part A1 drops, microprocessor 10 recognizes that there has been generation of either pulse signal P1, P2, or P4 with positive polarity. Transistor TR1 enters a blocked state because the base current ceases to flow when the charging of bias capacitor C1 has been completed.

Because bias capacitor C1 will be charged to the polarity shown in the figure when the base current flows to transistor TR1, bias voltage Vb is generated across both ends, raising the threshold value of the input circuit of the pulse signal. Subsequently, because transistor TR1 only conducts when a positive polarity pulse signal having a wave amplitude above bias voltage Vb across capacitor C1 occurs, only the pulse signals above bias voltage Vb are recognized as normal pulse signals, and pulse signals below bias voltage Vb are excluded as noise signals. Bias voltage Vb that may be obtained at both ends of capacitor C1 gradually decreases as the charge of capacitor C1 discharges through resistance R5.

When signal coil 402 generates the negative polarity pulse signals P3 and P5 as shown in the figure, current flows through the path consisting of signal coil 402—diode D4—capacitor C2—resistance R4—base emitter circuit of transistor TR2—diode D1—signal coil 402, leading transistor TR2 to conduct and reducing the potential of port A2 of microprocessor 10. The microprocessor recognizes that one of the negative polarity pulse signals P3 or P5 has been inputted by detecting a drop in the potential of this port A2.

Transistor TR2 enters a blocked state because the base current ceases to flow when the charging of capacitor C2 in the bias circuit has been completed. Because capacitor C2 is charged when the base current is flowing to transistor TR2, bias voltage Vb is generated across capacitor C2. Because transistor TR2 only conducts when a negative polarity pulse signal having a crest value that exceeds this bias voltage occurs, only the negative polarity pulse signal having a crest value that exceeds the bias voltage will be recognized by microprocessor 10, and the negative polarity pulse signal having a crest value below the bias voltage is eliminated as a noise signal.

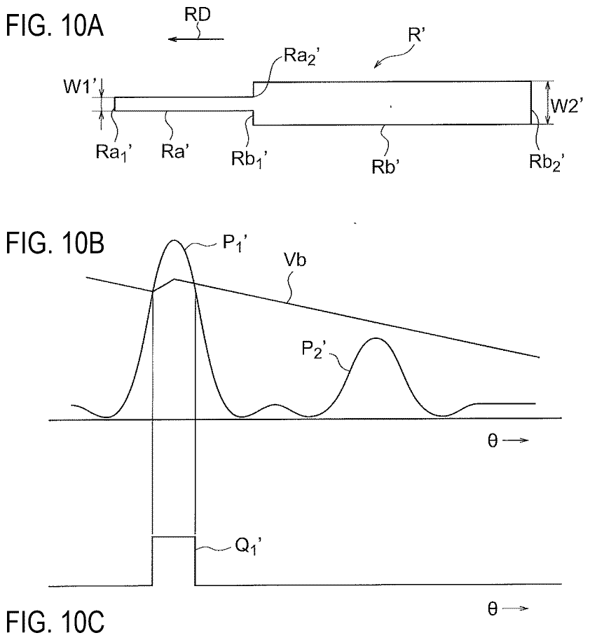

As explained using FIG. 10, if the crest value of second signal P2′ that may be generated when the second step reluctor is detected is less than or equal to bias voltage Vb, transistor TR2 cannot conduct, so second signal P2′ is eliminated as noise, and the controller is not provided information having second signal P2′ that was generated when the stator detected the second step reluctor.

In order to prevent this type of problem from occurring, as described above, Patent Literature 1 states that, by appropriately setting the relationship between the width dimension of the first step reluctor of the multi-stepped reluctor and the width dimension of the magnetic pole of the stator iron core, and the relationship between the width dimension of the second reluctor of the multi-stepped reluctor and the width dimension of the magnetic pole of the stator iron core, the crest value of the pulse signal that may be induced in the signal coil of the stator as the tip of the first step reluctor of the rotor passes through the position of the magnetic pole of the tip of the stator iron core will be the same as the crest value of the pulse signal that may be induced in the stator signal coil as the tip of the second step reluctor of the rotor passes through the position of the magnetic pole of the tip of the stator iron core. However, according to this proposal, there is a risk that the reluctor will increase in size, making it difficult to balance the rotor, and the width dimension of the first stage reluctor will become too small, causing the strength of the first stage reluctor to decrease.

In order to prevent such problems from occurring, according to the present invention, the part that was deformed such that it would act to control the changes that may occur in the magnetic flux flowing through the stator iron core when the tip of the first step reluctor of the rotor starts to face the magnetic pole of the stator iron core is provided at the tip of the first reluctor of the rotor and (or) in the magnetic pole of the stator iron core, making it possible to limit the crest value of the first signal that may be induced in the signal coil when the first step reluctor starts to face the magnetic pole of the stator iron coil to be equal to or less than the crest value of the second signal that may be induced in the signal coil when the second step reluctor starts to face the magnetic pole of the stator iron core.

In the present example of embodiment, as shown in FIGS. 2, 3 and 4, a part having roundness is formed at tip 303A1 of first step reluctor 303A, and this part having roundness forms said deformed part.

The part having roundness may be provided such that the rounded portion is only visible when tip 303A1 of first step reluctor 303A is viewed along the radial direction of the rotor without changing the thickness d of tip 303A1 of first step reluctor 303A as shown in FIGS. 3A and 3B, or it may be provided such that the rounded part is only visible when tip 303A1 of first step reluctor 303A1 is viewed along the axis direction of the rotor without changing the width dimension of tip 303A1 of first step reluctor 303A as shown in FIGS. 4A and 4B. Also, the shape of tip 303A1 of first step reluctor shown in FIG. 3 and the shape of tip 303A1 of first step reluctor shown in FIG. 4 may be combined to round tip 303A1 of the first step reluctor such that the rounded shape is visible when tip 303A1 of the first step reluctor is viewed along the radial direction of the rotor or along the axial direction of the rotor. As mentioned above, if it is not possible to ensure a uniform thickness between the part that constitutes the first step reluctor and the part that constitutes the second step reluctor at the periphery of the rotor yoke that was manufactured as in the case when manufacturing the rotor yoke through casting, the part that forms the reluctor may be treated by grinding or polishing in order to ensure that it has the same thickness d in first step reluctor 303A and second step reluctor 303B. In this case, the roundness that is visible when the reluctor is viewed along the axis direction of the rotor and is formed naturally by casting may disappear depending on the degree of processing.

The corners of the tip of second step reluctor 303B are usually formed to have a shape that does not have any roundness. However, if the width dimension of stator iron core 401, particularly magnetic pole 4a, is greater than width dimension w2 of second step reluctor 303B, the corners of the tip of second step reluctor 303B may have a roundness. This is because the rounded portion is located substantially outside of the magnetic path and has a smaller impact on the magnetic flux changes.

As described above, if tip 303A1 of the first step reluctor of the stepped reluctor is rounded, the change in the magnetic flux flowing through the stator iron core when tip 303A1 of the step reluctor 303A1 begins to face magnetic pole 4a of the tip of the stator iron core can be suppressed. Therefore, when compared to the case in which tip 303A1 of the first step reluctor is not rounded, the crest value of pulse signal (first signal) that may be induced in signal coil 402 can be reduced when tip 303A1 of first step reluctor 303A passes magnetic pole 4a of the tip of the stator iron core.

Therefore, without causing problems such as increasing the width dimension of second step reluctor 303B of the stepped reluctor and causing the width dimension of first step reluctor 303A to become too small, which may lead to a decrease in the strength of the first step reluctor, the crest value of the pulse signal (first signal) that may be generated when the stator detects the first step reluctor can be set to a size that is less than or equal to the crest value of the pulse signal (second signal) that may be generated when the stator detects the second step reluctor (preferably, the crest value will be equivalent to the crest value of the second signal) in order to prevent the occurrence of a situation in which the engine control unit does not recognize the signals that may be generated later.

As a method of making a rotor having a reluctor on the outer circumference of the rotor yoke, it is possible to envision a method of forming the reluctor by pressing a metal plate made of a ferromagnetic material to form a cup-shaped rotor yoke, and then casting a rotor with a reluctor on the outer circumference of the rotor yoke.

In the case of the former method, after forming the reluctor by stamping into the peripheral wall of the rotor yoke, it is acceptable to perform R-chamfering of the tip of the first step reluctor of the stepped reluctor. In this case, by simply adjusting the chamfering amount, it will be possible to limit the crest value of the pulse signal that may be generated when the tip of the first step reluctor passes the position of magnetic pole 4a of the stator iron core to be less than or equal to the crest value of the pulse signal that may be generated when the tip of the second step reluctor passes the position of the magnetic pole of the stator iron core.

In addition, when a rotor having a reluctor on the outer circumference of the rotor yoke is manufactured by casting, rounding is necessarily formed at the tip of the first step reluctor, so it will be possible to provide a deformed part with roundness without performing R-chamfering of the tip of the first step reluctor.

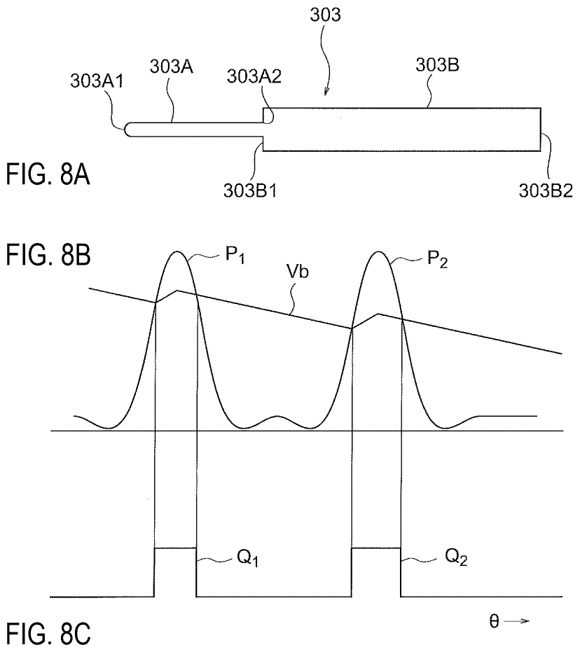

FIG. 8 shows the stepped reluctor to which the present invention has been applied, along with the waveform of the pulse signal that may be induced by the stepped reluctor in the signal coil. FIG. 8A shows a schematic representation of the shape of the stepped reluctor, with a rounded part formed at tip 303A1 of first step reluctor 303A as previously described.

FIG. 8B shows the waveform of pulse signals P1 and P2 that may be induced in the signal coil wound about the stator iron core when stepped reluctor 303 shown in FIG. 8A passes the position of the magnetic pole at the tip of the stator iron core, along with the waveform of the bias voltage Vb occurring across the capacitor of the bias circuit when these pulse signals are inputted into the engine control unit through the signal input circuit provided with a bias circuit.

In the case of applying the present invention to a stepped reluctor provided in a rotor, as shown in FIG. 8B, the crest value of pulse signal (first signal) P1 that may be induced in the signal coil as the tip of stepped reluctor 303A passes the position of magnetic pole 4a at the tip of the stator iron core can be made to be approximately equal to the crest value of pulse signal (second signal) P2 that may be induced in the signal coil as the tip of second step reluctor 303B passes the position of magnetic pole 4a of the tip of the stator iron core, ensuring that both pulse signals P1 and P2 can exceed the bias voltage Vb, and ensuring that the portions where pulse signals P1 and P2 exceed the bias voltage Vb can be inputted into the microprocessor of the engine control device as signals Q1 and Q2 as shown in FIG. 8C. Therefore, both the crank angle information provided by pulse signal P1 and the crank angle information provided by pulse signal P2 can be provided to the microprocessor to allow control of the engine without hindrance.

In the above-noted examples of embodiment, a part of the first step reluctor of the rotor of the signal generating device that was deformed to have a roundness was provided, but of each part of the corners facing the rear side of rotational direction RD of the rotor of magnetic pole 4a at the tip of stator iron core 401, the part facing the first step reluctor may also be formed to have a part with roundness, and this part with roundness may be used as the deformed part that can act to control the changes in the magnetic flux that may occur when the tip of the first reluctor starts to face the magnetic pole at the tip of the stator iron core.

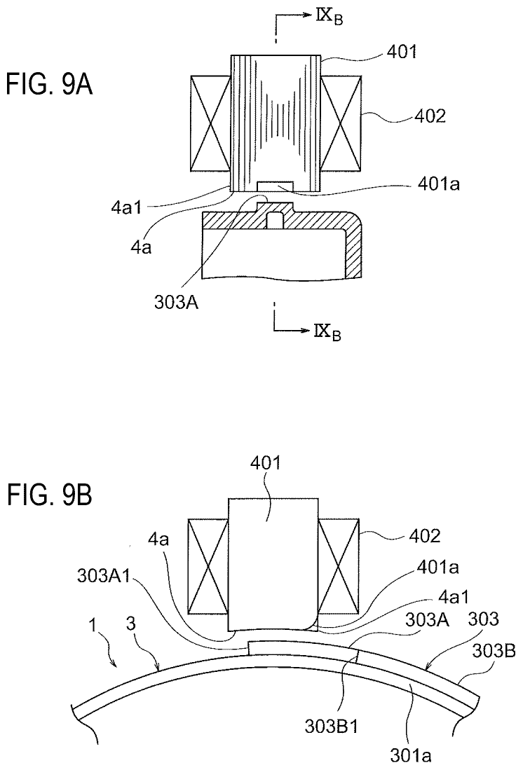

FIGS. 9A and 9B show an example of the side of magnetic pole 4a of stator iron core 401 having a deformed part such that the tip of first step reluctor 303A acts to control the changes in the magnetic flux that may occur when the tip of first step reluctor 303A starts to face magnetic pole 4a at the tip of stator iron core 401. In this example, of each part of corner 4a1 of magnetic pole 4a at the tip of stator iron core 401, part 401a having a roundness may be formed in the part that will initially face the tip of the first step reluctor during the process in which the rotor rotates, and said part having roundness constitutes the deformed part that may act to control the changes in the magnetic flux that may occur when the tip of the first step reluctor starts to face the magnetic pole at the tip of the stator iron core.

By providing a part that has been deformed such that it can act to control the changes in the magnetic flux that may occur when the tip of the first step reluctor starts to face the magnetic pole at the tip of the stator iron core on the side of the stator iron core, as shown in FIGS. 9A and 9B, it will be possible to ensure that the crest value of the pulse signal that may be generated when the stator has detected the first step reluctor will be the same size as the crest value of the pulse signal that may be generated with the stator has detected the second step reluctor.

The present invention is not limited to the above-noted examples of embodiment, and by providing a part that is deformed to have a roundness both at the tip of the first step reluctor and at the tip of the magnetic pole of the stator iron core, it will be possible to control the changes in magnetic flux that may occur when the tip of the first step reluctor of the rotor begins to face the magnetic pole of the tip of the stator iron core, ensuring that the crest value of the first signal and the crest value of the second signal are approximately the same.

1. A signal generating device for an engine, comprising:
a rotor rotatable along with an engine crank shaft, the rotor including a rotor yoke and, equipped in an outer periphery of the rotor yoke, a reluctor including a first step reluctor and a second step reluctor;
the first step reluctor having a first width dimension extending in a rotational direction of the engine crank shaft and a tip facing a forward direction of the rotational direction of the engine crank shaft;
the second step reluctor having a second width dimension, which is larger than the first width dimension, extending in the rotational direction of the engine crank shaft and a tip integrated with a rear end of the first step reluctor; and
a stator including:
a stator iron core having a magnetic pole disposed at a tip of the stator iron core that is sequentially faced by the first step reluctor and the second step reluctor during rotation of the engine crank shaft;
a signal coil wound about the stator iron core; and
a permanent magnet magnetically coupled with the stator iron core, the permanent magnet providing magnetic flux into a magnetic path that includes the stator iron core, the first step reluctor, and the second step reluctor;
wherein the stator is configured to induce a first signal and a second signal having the same polarity in the signal coil as a result of changes that occur in the magnetic flux when the tip of the first step reluctor starts to face the magnetic pole of the stator iron core and when the tip of the second step reluctor starts to face the magnetic pole of the stator iron core; and
wherein a deformed part disposed in the tip of the first step reluctor and/or in the magnetic pole of the stator iron core, the deformed part configured to control the changes in the magnetic flux when the tip of the first step reluctor starts to face the magnetic pole of the stator iron core such that a crest value of the first signal is limitable to a value that is equal to or less than a crest value of the second signal.

2. The signal generating device of claim 1, wherein the deformed part is defined by a portion having a roundness disposed at the tip of the first step reluctor.

3. The signal generating device of claim 1, wherein, of each part of a plurality of corners of the magnetic pole at the tip of the stator iron core, the part that will be first to face the tip of the first step reluctor during rotation of the rotor includes a part having a roundness that defines the deformed part.
